(19) United States
(12) Patent Application Publication
(10) Pub. No.: US 2011/0238423 A1
(43) Pub. Date: Sep. 29, 2011

(54) SONIC DOCUMENT CLASSIFICATION

(76) Inventors: David M. Schaertel, Webster, NY (US); Daniel P. Phinney, Rochester, NY (US); Swapnil Sakharshete, Rochester, NY (US)

(21) Appl. No.: 12/748,732

(22) Filed: Mar. 29, 2010

(51) Int. Cl. G10L 11/00

(52) U.S. Cl. 704/270; 704/E11.001

(57) ABSTRACT

An apparatus for classifying documents (5) based on sound includes a document transport (30) for transporting a document; an audio transducer (20) for detecting a sonic profile produced by the document as it is transported; and a controller for determining document characteristics based on the sonic profile.

### CROSS REFERENCE TO RELATED APPLICATIONS

Reference is made to commonly-assigned copending U.S. patent application Ser. No. ______ (Attorney Docket 96095/NAB), filed herewith, entitled A METHOD FOR SONIC DOCUMENT CLASSIFICATION, by Schaertel et al., the disclosure of which is incorporated herein.

### FIELD OF THE INVENTION

The invention relates in general to document classification, and in particular to classification of document weight or thickness based on sound captured by an audio transducer. Knowledge of document characteristics such as weight or thickness can be used by other scanner systems.

### BACKGROUND OF THE INVENTION

In a document transport system, documents having different thickness are scanned and passed through the transport. When a document is moving through a document transport there is an associated sound with movement of the document. This sound can be characterized by its spectral features. The sound characteristics of the document moving through the transport will vary based on the thickness of the document. These features can be used to classify documents.

In a document scanner, the weight of the document can translate to thickness and is related to the translucence of the document. Document scanners will often be used in such a way that many different weighted documents will be scanned within the same batch. These attributes of a document can require specific treatment by other systems such as an ultrasonic document detection system (UDDS), described in U.S. Pat. No. 6,511,064, wherein the thickness of the document attenuates the ultrasonic signal more than a lighter weight or thinner document. Knowing the weight or thickness of a document can enable system parameters to be adjusted to better meet the machine processing requirements of a given document.

Ultrasonic document detection can provide other useful information about a document that is being transported through a scanner. For example, the detector can determine if multiple documents are being fed, which may result in loss of information from the scanning process since some documents will not be scanned. Another problem is that often the detector can confuse a thick document with a multi-fed document. There is, therefore, a need for an improved determination of thickness of a document, whether a document is wrinkled, and whether multiple documents are stapled together.

### SUMMARY OF THE INVENTION

Briefly, according to one aspect of the present invention an apparatus for classifying documents based on sound includes a document transport for transporting a document; an audio transducer for detecting a sonic profile produced by the document as it is transported; and a controller for determining document characteristics based on the sonic profile.

In one embodiment, a document scanner captures an audio signal, using an audio transducer, of a document entering the scanner transport. The audio signal is then conditioned, digitized, and processed to provide spectral information with regard to the signal. The spectral information, sometimes referred to as a sonic profile, is then compared to known spectral attributes of different weighted documents for comparison and classification.

### BRIEF DESCRIPTION OF THE DRAWINGS

FIG. 1 is a side view of a document scanner showing the general location of an audio transducer used to acquire the audio signals of paper entering the document transport.

FIG. 2 shows a flowchart of system operation.

FIG. 3 shows a block diagram of a system used to classify a document.

### DETAILED DESCRIPTION OF THE INVENTION

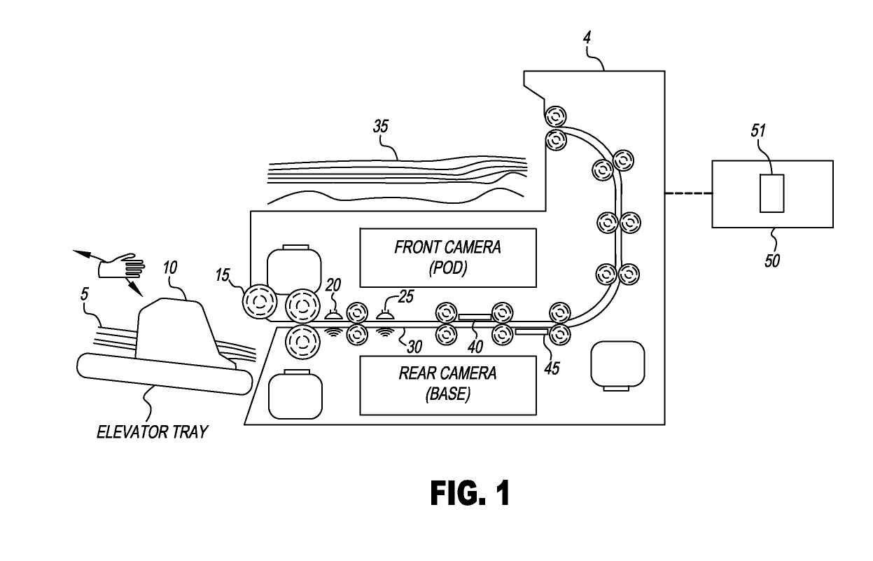

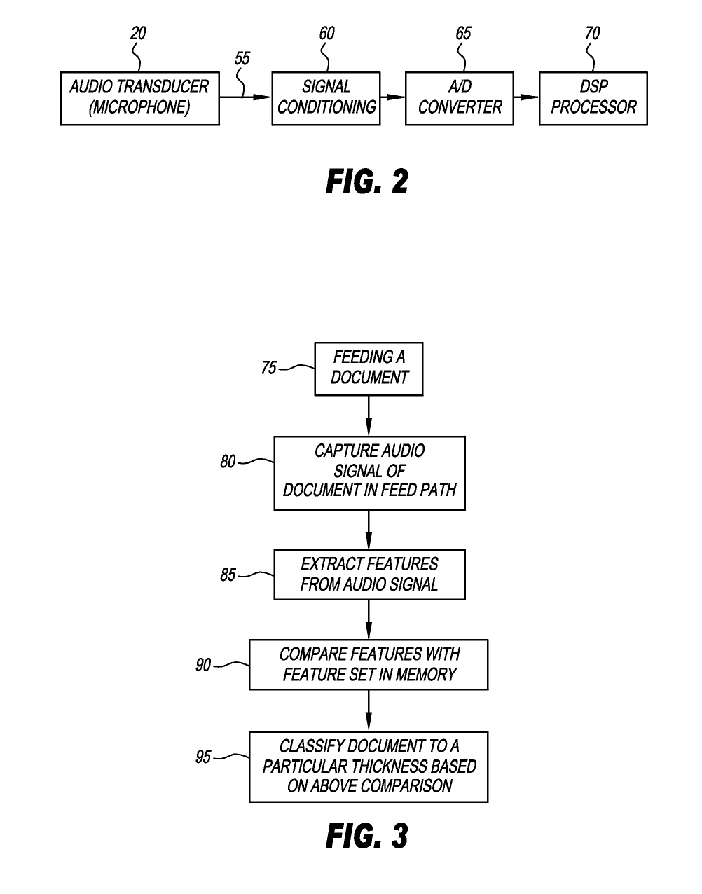

As shown in FIG. 1, documents 5 are fed from the input tray 10 of the scanner 4. When documents enter the scanner, the feed and separation rollers 15 separate the documents from one another, which produces sound. Different weighted documents make different sounds. The sounds of the document are picked up by the audio transducer 20, and the audio signal 55 is sent to be conditioned, digitized, and processed as shown in FIG. 2.

As shown in FIG. 1, the audio transducer 20 picks up the sound signal from the different thickness documents 5 entering a document transport 30. As shown in FIG. 2, signal conditioning 60 such as analog filtering may be applied to the audio signal before being processed. The conditioned analog signal is then sampled and digitized at an appropriate rate to avoid aliasing of the highest frequency present in the signal by an analog to digital A/D converter 65. The digital samples obtained from the A/D converter are processed in the digital signal processor (DSP) 70.

When feeding a document 75 into the scanner 4 the audio signal generated by the document is captured 80. Features are extracted from the audio signal 85 and compared to a feature set in memory 90. Based on the compared features of the captured audio signal and features in the feature set, the document is classified as a certain weight or thickness of document 95.

The document classification system basically consists of two phases, an audio phase and a classification phase. In the audio phase, various spectral features, or sonic profile, for example, like pitch or spectral centroid or amplitude or other, are determined in the audio signal for different thicknesses of paper. Features that are selected for learning purposes have good distinguishable properties for different thickness of documents. To generate the audio feature descriptors, windowed scan over the audio samples is used. The windowed scan includes sliding a window over the audio data in fixed increments, wherein each window represents a window of time. Spectral features are extracted from the sliding window using short time Fourier transform (STFT) techniques. STFT provides a rich representation that is capable of modeling a variety of perceptual characteristics such as pitch, loudness, amplitude, etc. These sets of feature vectors, corresponding to different document thicknesses are then stored in memory.

In the classification phase, the goal is to determine the category of a new document that is currently entering the scanner to a particular thickness based on the audio signal. The first step for classification is to extract the same spectral features as were determined in the learning phase. Classification of the document to a certain thickness is done by comparing these extracted features with the feature sets stored in the memory 51. Support vector machines (SVM) may be used for this comparison purpose.

While the audio signal is processed in the processor 50, the document continues moving through the transport 30. Processor 50 and memory 51 may be internal or external to scanner 4. Document thickness is determined and classified before the document reaches the ultrasonic sensor 25. The document continues through the transport 30 to the upper imaging area 40, lower imaging area 45, out of the transport 30, and into the document output area 35.

The invention has been described in detail with particular reference to certain preferred embodiments thereof, but it will be understood that variations and modifications can be effected within the scope of the invention.

### PARTS LIST

4 scanner
5 documents
10 input tray
15 feed and separation rollers
20 audio transducer
25 ultrasonic sensor
30 transport
35 document output area
40 upper imaging area
45 lower imaging area
50 processor
51 memory
55 audio signal
60 signal conditioning
65 A/D converter
70 DSP processor
75 feeding a document
80 capture audio signal of document in feed path
85 extract features from audio signal
90 compare features with feature set in memory
95 classify document to a particular thickness based on above comparison

1. An apparatus for classifying documents based on sound comprising:
a document transport for transporting a document;
an audio transducer for detecting a sonic profile produced by the document as it is transported; and
a controller for determining document characteristics based on the sonic profile.

2. The apparatus of claim 1 wherein said sonic profile is comprised of frequencies.

3. The apparatus of claim 2 wherein said sonic profile is comprised of an amplitude of different frequencies.

4. The apparatus of claim 1 wherein said sonic profile is captured over a period of time as the document is being transported.

5. The apparatus of claim 4 wherein said sonic profile is analyzed over a said time period.

6. The apparatus of claim 1 wherein transport sounds are filtered from said sonic profile prior to analysis.
